(19) United States
(12) Patent Application Publication
(10) Pub. No.: US 2026/0186711 A1
(43) Pub. Date: Jul. 2, 2026

(54) TRANSFER COMMAND POWER GATING WITHIN A MEMORY SYSTEM

(71) Applicant: Micron Technology, Inc., Boise, ID (US)

(72) Inventors: Liang Yu, Boise, ID (US); Jonathan S. Parry, Boise, ID (US)

(21) Appl. No.: 19/406,658

(22) Filed: Dec. 2, 2025

Related U.S. Application Data
(60) Provisional application No. 63/739,243, filed on Dec. 27, 2024.

(51) Int. Cl. G06F 3/06

(52) U.S. Cl. CPC G06F 3/0659; G06F 3/0625; G06F 3/0679

(57) ABSTRACT

Methods, systems, and devices for transfer command power gating within a memory system are described. A memory device may dynamically activate data path circuitry within the memory device according to an operation to be performed at the memory device. In response to receiving signaling that indicates a transfer of data stored in the memory device, the memory device may generate a power gating signal associated with activation of the data path circuitry. The signaling may include a command from a controller before a data transfer, a preamble associated with the data transfer, or both. The memory device may transfer the data via the data path using the activated data path circuitry in response to the signaling. The memory device may receive second signaling to deactivate the data path circuitry after the data transfer is complete to reduce power consumption and improve performance.

### CROSS REFERENCE

The present Application for Patent claims priority to U.S. Provisional Patent Application No. 63/739,243 by Yu et al., entitled “TRANSFER COMMAND POWER GATING WITHIN A MEMORY SYSTEM,” filed Dec. 27, 2024, which is assigned to the assignee hereof, and which is expressly incorporated by reference in its entirety herein.

### TECHNICAL FIELD

The following relates to one or more systems for memory, including transfer command power gating within a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports transfer command power gating within a memory system in accordance with examples as disclosed herein.

FIG. 2 shows an example of a memory system that supports transfer command power gating within a memory system in accordance with examples as disclosed herein.

FIG. 3 shows an example of a timing diagram that supports transfer command power gating within a memory system in accordance with examples as disclosed herein.

FIG. 4 shows a block diagram of a memory system that supports transfer command power gating within a memory system in accordance with examples as disclosed herein.

FIG. 5 shows a flowchart illustrating a method or methods that support transfer command power gating within a memory system in accordance with examples as disclosed herein.

### DETAILED DESCRIPTION

Some memory devices (e.g., NOT AND (NAND) memory devices, NAND logical unit numbers (LUNs), memory dies, memory chips) in a memory system may utilize data path circuitry (e.g., super low voltage (SLV) speed data path/page buffer circuitry) to transfer data to or from a memory array of the memory device via a data path. The data path may be, for example, a speed data path utilizing relatively fast or low latency complementary metal-oxide-semiconductors (CMOSs), or some other type of data path for conveying data within the memory system, which may include one or more memory devices. The data path circuitry may be different from other circuitry of the memory device that may process input and output (I/O) for the memory device or otherwise facilitate access operations within the memory device (e.g., an input/output buffer, a command status machine, a core logic, or the like that processes I/O for the memory array). A controller (e.g., an application specific integrated circuit (ASIC), a memory system controller, a host system) may enable or disable one or more memory devices within the memory system to perform an operation (e.g., read, write, erase) by issuing a chip enable (CE) signal to the intended memory device. In some cases, the controller may use a multi-die select (MDS) CE signal to enable multiple memory devices at once. In some examples, a CE signal may activate both the data path circuitry and the other circuitry of a memory device, irrespective of whether a subsequent operation to be performed after the chip is enabled in response to the CE signal uses the data path or not. For example, some operations enabled by the CE signal (e.g., erase operations, among other examples) may not include a transfer of data via the data path, but the single CE signal (e.g., or the MDS CE signal) may still activate the data path circuitry. Additionally, or alternatively, CE signals for different memory devices may sometimes activate the different memory devices for an overlapping time duration. In some cases, activation of the data path circuitry for non-data-transferring access operations and overlapping activation of different memory devices may cause power leakage associated with the data path circuitry, which may increase power usage at the memory system and reduce performance.

According to techniques described herein, a memory device may dynamically activate data path circuitry within the memory device (e.g., separately from activating the other circuitry) in response to an operation to be performed at the memory device. For example, data path circuitry at a memory device may remain, as a default, in an idle state (e.g., decoupled from a power source using power gating circuitry) regardless of a received CE signal. In response to receiving signaling from a controller that indicates an access associated with a transfer of data via the data path, the memory device (e.g., the other circuitry of the memory device) may generate a power gating signal associated with activation of the data path circuitry. Activating the data path circuitry may include disabling power gating circuitry coupled with the data path circuitry and coupling the data path circuitry with a power source. In some examples, the signaling may include an external command from the controller before a data transfer, a preamble (e.g., an extended preamble) associated with the data transfer, or both. Additionally, or alternatively, the memory device may receive second signaling (e.g., a second external command, a post-amble or extended post-amble, both) to deactivate the data path circuitry after the data transfer is complete. The memory device may thereby ensure that the data path circuitry is disabled when not in use for data path transfers, which may reduce leakage current and improve performance.

In some cases, logic circuitry (e.g., an AND comparator) may be coupled with the data path circuitry and configured to receive, as inputs, the power gating signal and the CE signal that enables the memory device. The logic circuitry (e.g., an output of the logic circuitry) may control (e.g., activate or deactivate) the data path circuitry in accordance with values of the CE signal, the power gating signal, or both. In some cases, a memory system controller (e.g., or a host system) may enable or disable the use of the power gating signal to control the data path circuitry (e.g., the separate power gating feature) for one or more memory devices of the memory system.

In addition to applicability in memory systems as described herein, techniques for transfer command power gating within a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by selectively activating or deactivating the data path circuitry for a data transfer (e.g., high speed NAND data transfer), which may reduce power leakage via the data path circuitry and thus improve a power performance of the memory system, among other benefits.

Features of the disclosure are illustrated and described in the context of systems, devices, and circuits. Features of the disclosure are further illustrated and described in the context of timing diagrams and flowcharts.

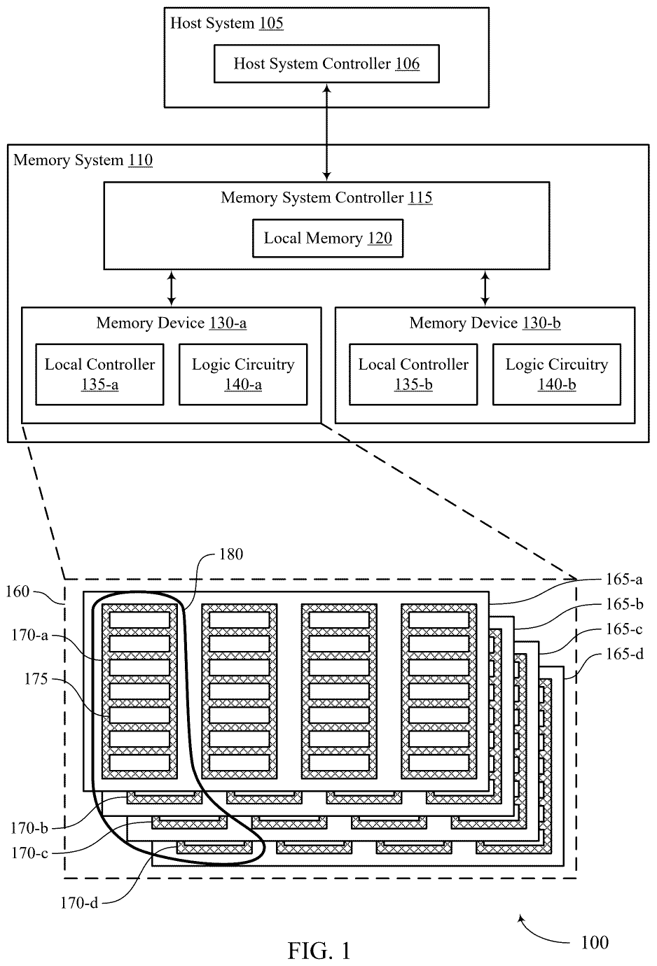

FIG. 1 shows an example of a system 100 that supports transfer command power gating within a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an ASIC, a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (mNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an ASIC, a digital signal processor (DSP)), or any other suitable processor or processing circuitry.

In some cases, a memory device 130 may be or include a NAND device (e.g., NAND flash device). A memory device 130 may be or include a memory die 160 (e.g., a die). For example, in some cases, a memory device 130 may be a package that includes one or more memory dies 160. A memory die 160 may, in some examples, be a piece of electronics-grade semiconductor cut from a wafer (e.g., a silicon die cut from a silicon wafer). Each memory die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-aand memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is an mNAND system.

According to techniques described herein, a memory device 130 (e.g., a memory die 160, a LUN) may dynamically activate data path circuitry within the memory device 130 (e.g., separately from activating other circuitry for processing inputs and outputs for the memory device 130) according to an operation to be performed at the memory device 130. For example, data path circuitry may remain, as a default, in an idle state (e.g., decoupled from a power source using power gating circuitry) regardless of a CE signal received at the memory device 130. In response to receiving both the CE signal and signaling from a controller (e.g., from the memory system controller 115, the local controller 135 of the memory device 130, or the host system 105) that indicates a transfer of data stored in a memory array of the memory device 130, the memory device 130 (e.g., the other circuitry of the memory device 130) may generate a power gating signal associated with activation of the data path circuitry. Activating the data path circuitry may include disabling power gating circuitry coupled with the data path circuitry (e.g., coupling the data path circuitry with a power source). In some examples, the signaling may include an external command from a controller (e.g., the local controller 135, the memory system controller 115, a host system 105) before a data transfer, a preamble (e.g., an extended preamble) associated with the data transfer, or both.

In some cases, the memory device 130 may receive second signaling (e.g., a second external command, a post-amble or extended post-amble, both) to deactivate the data path circuitry after the data transfer is complete. In some cases, logic circuitry 140 (e.g., logic circuitry 140-a, logic circuitry 140-b, AND comparators) of the memory device 130 (e.g., or the memory system 110) may be coupled with the data path circuitry and configured to receive, as inputs, the power gating signal and the CE signal that enables the memory device 130. The logic circuitry (e.g., an output of the logic circuitry) may control (e.g., activate or deactivate) the data path circuitry (e.g., using the power gating circuitry) using the CE signal, the power gating signal, or both. In some cases, the memory system controller 115 (e.g., or a host system 105) may enable or disable the use of the separate power gating feature for one or more memory devices 130 of the memory system. Alternatively, each memory device 130 of the memory system 110 may include one or more additional pins to provide a second CE signal between the memory system controller 115 and each memory device 130 to provide the separate power gating feature. The techniques described herein may reduce power leakage at the memory system 110 if data path circuitry of a memory device 130 is not being used for data transfer and the memory device 130 is enabled via the CE signal.

The system 100 may include any quantity of non-transitory computer readable media that support transfer command power gating within a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

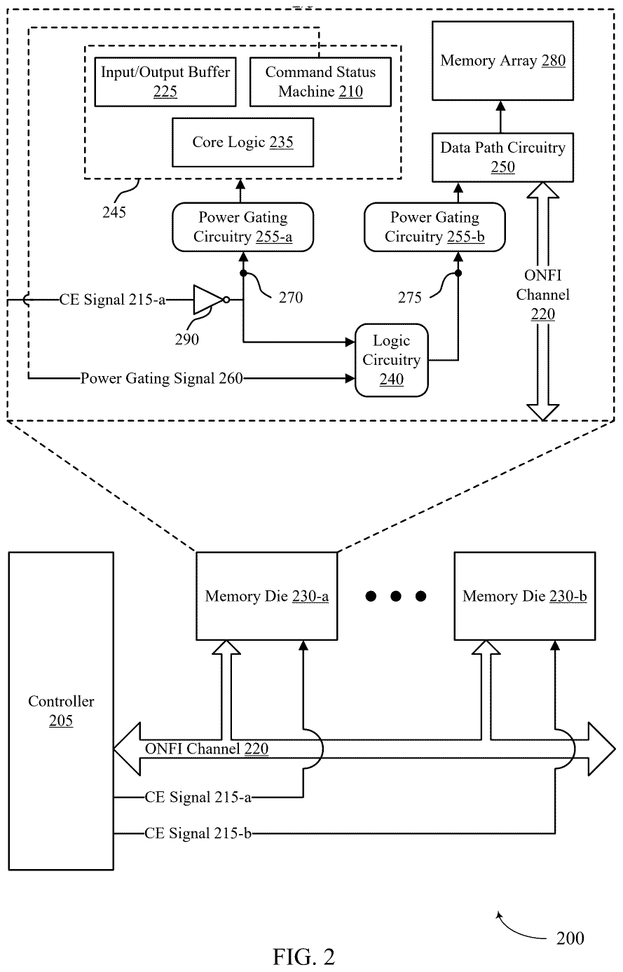

FIG. 2 shows an example of a memory system 200 that supports transfer command power gating within a memory system in accordance with examples as disclosed herein. In some cases, aspects of the memory system 200 may implement or be implemented by aspects of the system 100 illustrated in FIG. 1. For example, the memory system 200 may include one or more memory dies 230 (e.g., a memory die 230-a, a memory die 230-b), which may represent examples of LUNs, examples of the memory dies 160, the memory devices 130, or another portion of the memory devices 130 of FIG. 1, a controller 205 (e.g., an ASIC or other type of controller that represents the memory system controller 115 or the local controller 135 of FIG. 1), a memory array 280 (e.g., a plurality of memory cells, such as a portion of the memory die 160 of FIG. 1), and an ONFI channel 220 (e.g., such as the ONFI described with respect to FIG. 1, or some other type of channel within a memory system). The memory system 200 may further include one or more CE signals 215 (e.g., a CE signal 215-a, a CE signal 215-beach associated with respective pins), data path circuitry 250 configured to control transfers of data via a data path within the ONFI channel 220, and circuitry 245 (e.g., an example of other circuitry different from the data path circuitry 250). As described herein, each memory die 230 may support dynamic activation and deactivation of respective data path circuitry 250 during operation of the memory die 230 using the logic circuitry 240, a CE signal 215, and a power gating signal 260.

In some cases, a memory die 230 may incur relatively large current leakage (e.g., active current leakage of around 15 milliamp (mA) to 80 mA, or some other value, due to, for example, array read and write currents (ICCQ1 and ICCQ2, respectively), I/O burst read and write currents (ICCQ4R and ICCQ4W), or both) associated with the data path circuitry 250. The current leakage may be associated with a relatively high short-channel effect of the low voltage PMOSs of one or more low voltage (e.g., super low voltage) p-channel metal-oxide semiconductors (PMOSs) in the data path circuitry 250, which may cause a drain induced barrier lowering (DIBL) effect. Such current leakage may occur if the data path circuitry 250 is activated using a CE signal 215 for the memory die 230, but the data path circuitry 250 is not used for a transfer of data.

For example, if the logic circuitry 240 is not included in a memory die 230 and if a CE signal 215 activates the memory die 230 (e.g., the CE signal 215 for the memory die is set to a low value in the case that an inverter 290 is present), both power gating circuitries 255 (e.g., power gating circuitry 255-a and 255-b) may be deactivated, which may couple the data path circuitry 250 with a power source. That is, the CE signal 215 for a memory die 230 may disable power gating circuitry 255 which may activate the data path circuitry 250, and a current leakage associated with activating the data path circuitry 250 may reduce performance of the memory die 230. Deactivating the memory die 230 via the CE signal 215 (e.g., setting the CE signal 215 to a high value if the inverter 290 is present) may enable power gating circuitry 255 and deactivate the data path circuitry 250, which may reduce current leakage of the memory system to a standby current leakage, which may be relatively small.

In some cases, the power gating circuitry 255 may be circuitry to perform power gating for circuitry within a memory die 230. Power gating may include decoupling circuitry from a power source, or reducing a power supplied to the circuitry. Disabling power gating circuitry 255 may couple associated circuitry with a power source, or increase a power supplied to the associated circuitry.

This coupled power gating feature (e.g., where a CE signal 215 associated with a memory die 230 may control the power gating circuitry 255-a and the power gating circuitry 255-b) may support the design of one or more ONFI protocols, in some examples. For example, the memory system 200 may include an ONFI channel 220, and may operate according to the one or more ONFI protocols. As an example, if the controller 205 has ONFI signaling to transmit to the memory die 230-a, the controller 205 may activate (e.g., select) the memory die 230-a using the CE signal 255-a (e.g., disabling the power gating circuitry 255-a and 255-b), transmit the ONFI signaling to the memory die 230-avia the ONFI channel 220, and then deactivate the memory die 230-a using the CE signal 215-a in response to the accesses for the memory die 230-a being complete (e.g., enable the power gating circuitry 255-a and 255-b).

In some cases, the CE signal 215 may activate the power gating circuitry 255-a and the power gating circuitry 255-b regardless of whether an associated subsequent operation at the memory die 230 uses a data path (e.g., a data path coupling the data path circuitry 250 and the ONFI channel 220). For example, one or more operations indicated by the ONFI signaling may not utilize the data path (e.g., or the coupled data path circuitry 250), and thus activating the data path circuitry 250 during such operations may incur increase current leakage without utility. For example, such operations may include indicating a command, indicating an address, a feature data operation, status register (SR) polling cycles, erase operations, or other operations. Thus, such ONFI signaling (e.g., any command, address, set feature, get feature, data status register (SR) polling cycles) that accesses the memory die 230-a but does not trigger a data transfer via the data path may unnecessarily activate the data path circuitry 250, which may incur relatively large current leakage associated with the data path circuitry 250.

Additionally, or alternatively, current leakage may occur from a second memory die (e.g., the memory die 230-b) being activated (e.g., via a respective CE signal, CE signal 215-b) while a first memory die (e.g., the memory die 230-a) is activated. For example, in order to provide the memory die 230-b sufficient time to activate and prepare for receiving ONFI signaling via the ONFI channel 220, the controller 205 may set the CE signal 215-b to activate the memory die 230-b before setting the CE signal 215-a to deactivate the memory die 230-a, such that an activation of the memory dies 230-a and 230-b may overlap in time for a period. Such overlap of activation of the memory dies 230 (e.g., and thus the data path circuitry 250 of both memory dies 230) may lead to increased current leakage in a memory system.

Thus, the techniques described herein provide for dynamic activation and deactivation of the data path circuitry 250 according to a type of access operation to reduce current leakage and improve performance. For example, to reduce activation of the data path circuitry 250 and thus reduce a current leakage of the memory system 200 while maintaining compliance of the memory system 200 with the ONFI protocols or other protocols for data storage, each memory die 230 may generate a power gating signal 260 that dynamically activates (e.g., via the logic circuitry 240 and the power gating circuitry 255-b) the data path circuitry 250. For example, a memory die 230 may generate the power gating signal 260 (e.g., set the power gating signal 260 to a high value) to activate the data path circuitry 250 if the memory die 230 receives signaling through the ONFI channel 220 that is associated with transferring data using the data path. The memory die 230 may deactivate the data path circuitry 250 otherwise (e.g., if there is not an indication of a data transfer).

The logic circuitry 240 (e.g., an AND comparator, one or more other logic gates) may be included in each memory die 230 to facilitate the activation and deactivation of the data path circuitry 250. The logic circuitry 240 at the memory die 230 may receive, as inputs, the CE signal 215 (e.g., an inverted CE signal 215 because of the inverter 290) and the power gating signal 260. An output of the logic circuitry 240 may be coupled with the power gating circuitry 255-b (e.g., instead of the CE signal 215 being directly coupled with the power gating circuitry 255-b), such that the power gating circuitry 255-b may be deactivated (e.g., activating the data path circuitry 250) in accordance with a logical combination of the CE signal 215 and the power gating signal 260. The power gating circuitry 225-a associated with the circuitry 245 may still be coupled directly with the CE signal 215-a and the inverter 290, such that the circuitry 245 may be activated or deactivated directly in response to the CE signal 215-b.

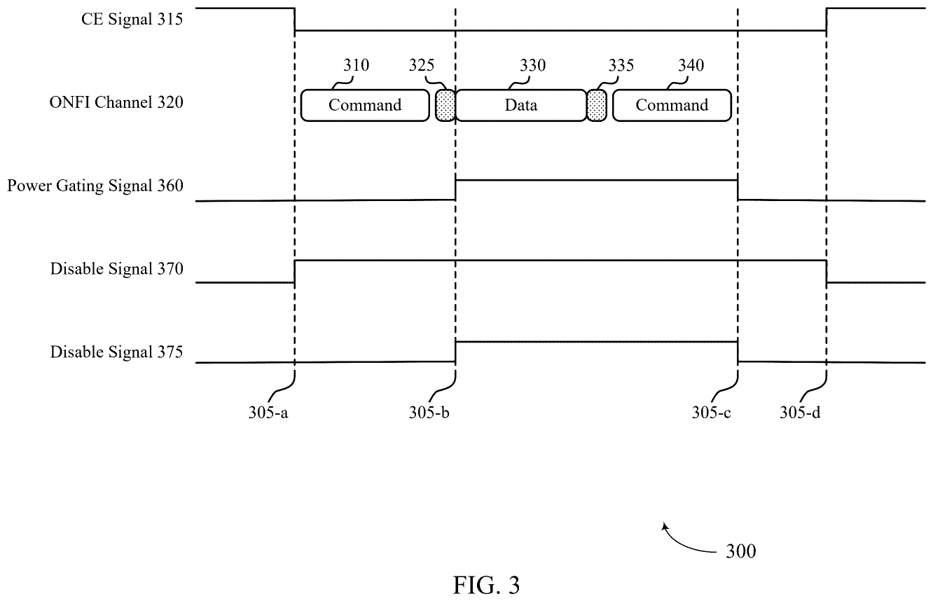

In some cases, the memory die 230 may set (e.g., to a high value, “1”) and reset (e.g., to a low value, “0”) the power gating signal 260 (e.g., a super low voltage power gating (SLV_PG) signal) in response to signaling sent to the memory die 230 via the ONFI channel 220 (e.g., via one or more command pins of the ONFI channel 220, via one or more data pins of the ONFI channel). For example, one or more portions of the circuitry 245 (e.g., a command status machine 210, an input/output buffer 225, a core logic 235, or any combination thereof) may generate (e.g., set) the power gating signal 260 in response to the received signaling. In some cases, the signaling may include an external command from the controller 205 (e.g., transmitted via one or more command pins of the ONFI channel 220, from a memory system controller 115, from a host system 105), a preamble associated with the data transfer (e.g., transmitted via one or more data pins of the ONFI channel 220), or both. Such indications for setting the power gating signal 260 are described in further detail elsewhere herein, including with reference to FIG. 3.

If the signaling is an external command, the external command may be of one or more types of commands. For example, the external command may include one or more existing commands (e.g., may re-use a command that is also used to indicate other operations different from the data transfer) if a UFS firmware associated with the memory system 200 confirms that the one or more existing commands are to be used for the separate power gating feature. Additionally, or alternatively, the external command may include one or more dedicated commands for a separate power gating feature (e.g., one or more commands configured to indicate a subsequent data transfer). In some cases, the external command may add relatively little latency compared to the data transfer via the ONFI channel 220 (e.g., tens of nanoseconds versus tens of microseconds, respectively). Thus, a relatively small amount of current used to transmit the external command (e.g., or the preamble) may not significantly detract from the reduction in current leakage produced by these techniques.

In some examples, the signaling may be a preamble configured to indicate (e.g., specific to) the separate power gating feature. For example, the contents or size of the preamble may indicate, to the memory die 230, that a transfer of data will occur. In some cases, the preamble may be an extended preamble (e.g., increased in a time duration compared to other preambles) to allow the memory die 230 sufficient time to receive the preamble, determine that a transfer of data via the data path may occur, and generate (e.g., set) the power gating signal 260. In some cases, the controller 205 may be configured to transmit such an extended preamble to indicate the transfer of data if the controller 205 detects that an ONFI operation includes a data transfer (e.g., via the data path).

In some cases, the signaling for the separate power gating feature (e.g., that indicates the transfer of data) may be transmitted before and after an ONFI data transfer. For example, the signaling may include a first signal (e.g., a first external command, a preamble, both) that indicates to set the power gating signal 260 (e.g., to a high value, a value of “1”), where the first signal may be communicated via the ONFI channel 220 prior to a transfer of data. The signaling may also include a second signal (e.g., second signaling, a second external command, a post-amble, or both) that indicates to reset the power gating signal 260 (e.g., to a low value, a value of “0”), where the second signal may be communicated via the ONFI channel 220 after the transfer of the data. Thus, by setting the power gating signal to allow data transfer via the data path and then resetting the power gating signal 260 (e.g., activating the power gating circuitry 255-b and deactivating the data path circuitry 250), the memory system 200 may reduce a current leakage associated with the data path circuitry 250 and improve a performance of the memory system 200.

In some cases, the ONFI channel 220 may be a single interface coupling the controller 205 to each memory die 230, and thus the CE signals 215 may indicate, to a memory die 230, that signaling over the ONFI channel 220 is intended for the memory die 230 (e.g., instead of a different memory die 230, as defined in one or more standards documents). The techniques of the present disclosure may additionally, or alternatively, include an additional pin at each memory die 230, where the additional pin is configured to receive a second CE signal (e.g., not shown in FIG. 2) from the controller 205. Each second CE signal may control (e.g., activate or deactivate) the power gating circuitry 255-b of a respective memory die 230 separately from the first CE signal 215 that controls the activation and deactivation of the power gating circuitry 255-a. For example, the controller 205 (e.g., a memory system controller) may be configured to activate the power gating circuitry 255 of a memory die 230 using both of the two CE signals according to ONFI signaling to be sent to the memory die 230, such that the controller 205 may activate the power gating circuitry 255-busing the second CE signal for a memory die 230 if the ONFI signaling is associated with transferring data via the data path associated with the data path circuitry 250.

The memory system 200 may include a node 270 and a node 275 associated with the power gating circuitry 255-a and the power gating circuitry 255-b, respectively. In some cases, a signal at the node 270 may be referred to as a power on reset (POR) power gating signal (e.g., POR_PG_Disable signal). If the signal at the node 270 is high, the power gating circuitry 255-a may be disabled, and thus the circuitry 245 may be activated (e.g., coupled with a power source). If the signal at the node 270 is low, the power gating circuitry 255-a may be enabled (e.g., activated), and thus the circuitry 245 may be deactivated (e.g., decoupled from the power source). A signal at the node 275 may be a disable signal for the data path circuitry 250 that is separate from the signal at the node 270. Similar to the signal at the node 270, the signal at the node 275 may be high to disable the power gating circuitry 255-b and activate the data path circuitry 250 (e.g., couple the data path circuitry 250 with a power source) and may be low to enable the power gating circuitry 255-b and deactivate the data path circuitry 250 (e.g., decouple the data path circuitry 250 from the power source). Due to these separate signals (e.g., resulting from the power gating signal 260 and the logic circuitry 240), the circuitry 245 may be activated without activating the data path circuitry 250 (e.g., so the current leakage may not be affected by the DIBL of the data path circuitry 250), and a current leakage of the memory system 200 may be reduced (e.g., to a standby current leakage associated with the data path circuitry 250).

In some cases, the techniques described herein may be compatible with controllers (e.g., controllers 205, host systems 105, memory system controllers 115) that may not support or utilize the separate power gating feature (e.g., that may not support generation or transmission of the signaling that indicates the transfer of data and triggers the generation of the power gating signal 260). For example, a memory die 230 may be configured to set the power gating signal 260 to a high value upon power up of the memory die 230, such that the signal at the node 270 may control (e.g., activate or deactivate) the power gating circuitry 255-a and 255-b. If the controller 205 does not transmit signaling over the ONFI channel 220 that indicates the transfer of data (e.g., the external command or the preamble), the power gating signal 260 may remain set (e.g., to the high value). Then, to use the separate power gating feature (e.g., in auto or any ICCQ sensitive conditions), the controller 205 (e.g., mNAND firmware) may send activation signaling over the ONFI channel 220 to activate the separate power gating feature. In some cases, the activation signaling may be the same as the signaling that indicates the transfer of the data (e.g., the external command, the preamble) or a variation of such signaling (e.g., an external command with a token “0,” a specified preamble). In response to receiving the activation signaling, the memory die 230 may reset the power gating signal 260 to a low value (e.g., “0”). After activating the separate power gating feature, the controller 205 may send the signaling over the ONFI channel 220 that indicates the transfer of data to set and reset the power gating signal 260, as described herein.

FIG. 3 shows an example of a timing diagram 300 that supports transfer command power gating within a memory system in accordance with examples as disclosed herein. In some cases, aspects of the timing diagram 300 may implement or be implemented by aspects of the system 100 and the memory system 200, as described with reference to FIGS. 1 and 2. For example, the timing diagram 300 illustrates one or more signals (e.g., relative voltage levels of signals, commands, data transfers) communicated in the memory system 200 (e.g., in the system 100, between or within the controller 205 and a memory die 230). The signals include a CE signal 315 (e.g., an example of the CE signals 215), signals communicated over an ONFI channel 320 (e.g., an example of the ONFI channel 220), a power gating signal 360 (e.g., an example of the power gating signal 260), and disable signals 370 and 375 (e.g., examples of the signals at the nodes 270 and 275, respectively).

In some aspects, a memory die (e.g., a NAND memory LUN, a memory die 230, a memory device 130, a memory die 160) may receive signaling (e.g., a command 310, a preamble 325) that indicates a transfer of data 330 via a data path of the memory die (e.g., the data path). As described herein, such an indication of the transfer of data 330 may trigger the memory die to generate a power gating signal 360 (e.g., to set the power gating signal 360 to a high value (e.g., “1”)), and the memory die may transfer the data 330 via the data path in accordance with the power gating signal 360 activating data path circuitry (e.g., the data path circuitry 250) associated with the data path.

Before a time 305-a, the memory die may be initialized (e.g., not shown in FIG. 3). For example, a memory system comprising the memory die (e.g., the system 100, the memory system 200) may be powered on, or the memory die may be initially coupled with the ONFI channel 320. In response to initializing the memory die, activation signaling may be received at the memory die (e.g., via the ONFI channel 320, as described with respect to FIG. 2) that enables the separate power gating feature at the memory die (e.g., the use of power gating signaling to control data path circuitry 250 in the memory die). For example, a controller (e.g., the controller 205 of FIG. 2, the host system 105, the memory system controller 115, or the local controller 135 of the memory die) may transmit the activation signaling to the memory die.

At time 305-a, a CE signal 315 may be received. For example, the controller may transmit (e.g., send, set) the CE signal 315 to the memory die. The memory die may receive a high CE signal 315 that is inverted to a low signal using the inverter 290, in some examples. In some cases, the CE signal 315 may enable the memory die (e.g., the memory array 280 of the memory die) to receive inputs and to transmit outputs (e.g., may enable the circuitry 245). For example, the CE signal 315 may cause the disable signal 370 to transition to a high value, which may deactivate the power gating circuitry 255-a and thus activate the circuitry 245.

After the time 305-a, signaling that indicates a transfer of data 330 stored in the memory die (e.g., the memory array 280) may be received. For example, the controller may transmit (e.g., send) signaling that indicates the transfer of the data 330 to the memory die. In some cases, the memory die may receive the signaling that indicates the transfer of the data 330 in accordance with the CE signal 315 (e.g., in response to the CE signal 315 going low at time 305-a), in accordance with the separate power gating feature being enabled, or both. In some cases, the signaling that indicates the transfer of the data 330 may include the command 310 (e.g., an external command from the controller, as described with respect to FIG. 2), where the command 310 may request generation of the power gating signal 360 at a time 305-b. In some cases, the memory die may receive the command 310 via a command pin of the ONFI channel 320. Additionally, or alternatively, the signaling that indicates the transfer of the data 330 may include the preamble 325, which may be associated with transferring the data 330 via the data path (e.g., the data path). In some cases, the memory die may receive the preamble via a data pin of the ONFI channel.

In some cases, a data transfer command may be received before or after receiving the command 310, before receiving the preamble 325, or both. For example, the controller may transmit the data transfer command to the memory die, where the data transfer command may request the transfer of the data 330 via the data path at the time 305-b.

At the time 305-b, the power gating signal 360 may be generated (e.g., set to a high value). For example, the memory die may generate (e.g., set) the power gating signal 360 in response to receiving the signaling that indicates the transfer of the data (e.g., the command 310, the preamble 325, or both). The power gating signal 360 may be associated with activation of the data path circuitry 250 to transfer the data 330 via the data path of the memory die (e.g., and a data cache associated with the memory array 280). As described with respect to FIG. 2, the data path circuitry 250 may be different from other circuitry (e.g., the circuitry 245) configured to process input and output for the memory die (e.g., for the memory array 280). In some cases, the other circuitry of the memory die may generate (e.g., set) the power gating signal 360 in response to receiving the command 310, the preamble 325, or both. Additionally, or alternatively, a local controller 135 of the memory die may generate the power gating signal 360.

The memory die may activate the data path circuitry 250 according to both the CE signal 315 that enables the memory die and the power gating signal 360. For example, the memory die may comprise logic circuitry (e.g., the logic circuitry 240), and the CE signal 315 and the power gating signal 360 may be inputs to the logic circuitry. The disable signal 375 may be an output of the logic circuitry and may control the power gating circuitry 255-b, such that inputs to the logic circuitry at the time 305-b (e.g., the high value for the power gating signal and the inverted low value for the CE signal 315) may cause the disable signal 375 to go high and deactivate the power gating circuitry 255-b (e.g., activating the data path circuitry 250, as described with respect to FIG. 2).

Beginning at time 305-b, the data 330 may be transferred. For example, the memory die may transfer the data 330 (e.g., data stored in the memory array 280 of the memory die) via the data path and the ONFI channel 320 in response to the signaling that indicates the transfer of the data 330 (e.g., and the data transfer command). The memory die may transfer the data 330 in accordance with the activation of the data path circuitry 250 in response to the power gating signal 360 (e.g., and the CE signal 315).

After transferring the data 330 via the data path, second signaling that indicates an end of the transfer of the data 330 may be received. For example, the controller may transmit (e.g., send, output) the second signaling to the memory die via the ONFI channel 220. In some cases, the second signaling may include a post-amble 335 associated with the transfer of the data 330 (e.g., associated with a command sequence for transferring the data 330 via the data path), a command 340 (e.g., a second command), or both. If the second signaling includes the post-amble, the post-amble may be an extended post-amble (e.g., similar to the extended preamble described with respect to FIG. 2).

At time 305-c, a power gating signal 360 associated with deactivation of the data path circuitry 250 may be generated (e.g., the power gating signal 360 may be reset to a low value, a second power gating signal may be generated). For example, the memory die (e.g., the circuitry 245, a local controller 135) may generate the power gating signal in response to the second signaling that indicates the end of the transfer of the data 330. In some cases, the power gating signal at time 305-c may deactivate the data path circuitry 250 via the logic circuitry 240 and the power gating circuitry 255-b. For example, the second power gating signal may be an input to the logic circuitry 240 of the memory die, and the input may cause the logic circuitry to reset the disable signal 375 (e.g., an output of the logic circuitry 240) to a low value to activate the power gating circuitry 255-b and deactivate the data path circuitry 250.

At a time 305-d, a CE signal 315 may be received (e.g., reset to a high value). For example, the controller may reset the CE signal 315 for the memory die to a high value, and the high value of the CE signal 315 may be received at the memory die (e.g., at a local controller 135 of the memory die, at the circuitry 245 of the memory die). In some cases, the CE signal (e.g., the inverted CE signal 315) at time 305-d may disable the circuitry 245 of the memory die. For example, the CE signal 315 at time 305-d may cause the disable signal 370 to transition to a low value, which may activate power gating circuitry 255-d and disable the circuitry 245.

In some cases, the techniques described herein may be performed sequentially on a single memory die (e.g., a single NAND LUN) of a memory system for different transfers of data, serially across multiple memory dies of the memory system for different transfers of data, or in a parallel manner with multiple memory dies of the memory system for parallel transfers of data. Thus, a memory die may control the activation of the data path circuitry 250 for a transfer of data 330 separately from activation of other circuitry of the memory die, which may reduce current leakage at the memory system and improve system performance.’

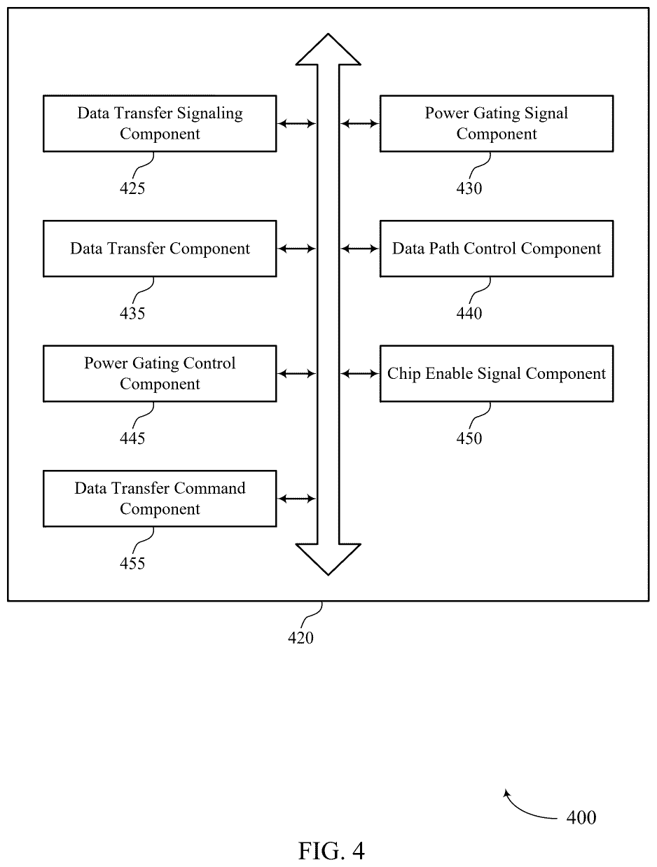

FIG. 4 shows a block diagram 400 of a memory system 420 that supports transfer command power gating within a memory system in accordance with examples as disclosed herein. The memory system 420 may be an example of aspects of a memory system as described with reference to FIGS. 1 through 3. The memory system 420, or various components thereof, may be an example of means for performing various aspects of transfer command power gating within a memory system as described herein. For example, the memory system 420 may include a data transfer signaling component 425, a power gating signal component 430, a data transfer component 435, a data path control component 440, a power gating control component 445, a chip enable signal component 450, a data transfer command component 455, or any combination thereof. Each of these components, or components of subcomponents thereof (e.g., one or more processors, one or more memories), may communicate, directly or indirectly, with one another (e.g., via one or more buses).

The memory system 420 may support memory operations in accordance with examples as disclosed herein. The data transfer signaling component 425 may be configured as or otherwise support a means for receiving signaling that indicates a transfer of data stored in a memory array of the memory system. The power gating signal component 430 may be configured as or otherwise support a means for generating, in response to the signaling that indicates the transfer of the data, a power gating signal associated with activation of data path circuitry to transfer the data via a data path associated with the memory array, where the data path circuitry is different from other circuitry to process input and output for the memory array. The data transfer component 435 may be configured as or otherwise support a means for transferring, in accordance with the activation of the data path circuitry in response to the power gating signal, the data stored in the memory array via the data path in response to the signaling.

In some examples, to support receiving the signaling, the data transfer signaling component 425 may be configured as or otherwise support a means for receiving a command that indicates the transfer of data and that requests generation of the power gating signal.

In some examples, to support generating the power gating signal, the power gating signal component 430 may be configured as or otherwise support a means for generating, by the other circuitry to process the input and output for the memory array, the power gating signal in response to the command.

In some examples, the data transfer command component 455 may be configured as or otherwise support a means for receiving a data transfer command before or after receiving the command, where the data transfer command requests the transfer of the data via the data path.

In some examples, to support receiving the signaling, the data transfer signaling component 425 may be configured as or otherwise support a means for receiving a preamble associated with transferring the data via the data path, where generating the power gating signal is in response to the preamble.

In some examples, the data transfer signaling component 425 may be configured as or otherwise support a means for receiving, after transferring the data via the data path, second signaling that indicates an end of the transfer of the data. In some examples, the power gating signal component 430 may be configured as or otherwise support a means for generating, in response to the second signaling that indicates the end of the transfer of the data, a second power gating signal associated with deactivation of the data path circuitry.

In some examples, the data path control component 440 may be configured as or otherwise support a means for deactivating the data path circuitry according to the second power gating signal including an input to logic circuitry of the memory system that is to activate or deactivate the data path circuitry according to the input.

In some examples, the second signaling includes a post-amble associated with a command sequence for transferring the data via the data path or a command that indicates to generate the second power gating signal, or both.

In some examples, the data path control component 440 may be configured as or otherwise support a means for activating the data path circuitry according to both a chip enable signal that enables the memory array and the power gating signal including inputs to logic circuitry of the memory system that is to activate or deactivate the data path circuitry according to the inputs.

In some examples, the power gating control component 445 may be configured as or otherwise support a means for receiving, in response to powering on the memory system, second signaling that enables use of power gating signaling to control the data path circuitry, where the signaling that indicates the transfer of the data is received in accordance with the use of power gating signaling to control the data path circuitry being enabled.

In some examples, the chip enable signal component 450 may be configured as or otherwise support a means for receiving a chip enable signal that enables the memory array to receive the input and the output, where the signaling that indicates the transfer of the data is received in accordance with the chip enable signal.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

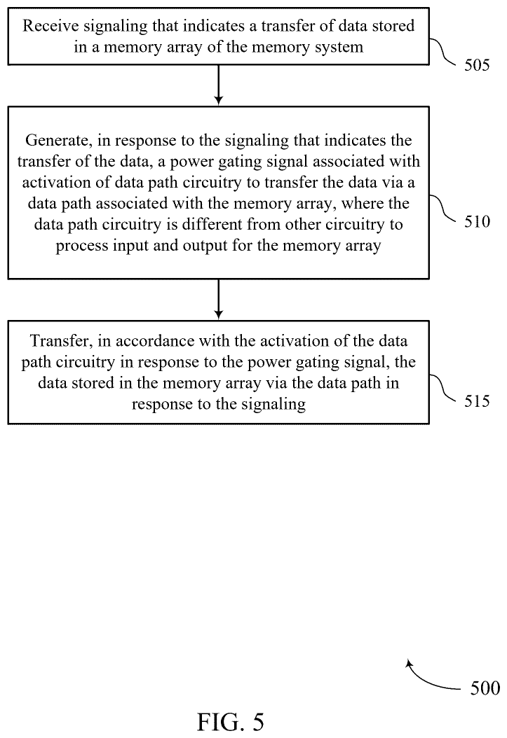

FIG. 5 shows a flowchart illustrating a method 500 that supports transfer command power gating within a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving signaling that indicates a transfer of data stored in a memory array of the memory system. In some examples, aspects of the operations of 505 may be performed by a data transfer signaling component 425 as described with reference to FIG. 4.

At 510, the method may include generating, in response to the signaling that indicates the transfer of the data, a power gating signal associated with activation of data path circuitry to transfer the data via a data path associated with the memory array, where the data path circuitry is different from other circuitry to process input and output for the memory array. In some examples, aspects of the operations of 510 may be performed by a power gating signal component 430 as described with reference to FIG. 4.

At 515, the method may include transferring, in accordance with the activation of the data path circuitry in response to the power gating signal, the data stored in the memory array via the data path in response to the signaling. In some examples, aspects of the operations of 515 may be performed by a data transfer component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving signaling that indicates a transfer of data stored in a memory array of the memory system; generating, in response to the signaling that indicates the transfer of the data, a power gating signal associated with activation of data path circuitry to transfer the data via a data path associated with the memory array, where the data path circuitry is different from other circuitry to process input and output for the memory array; and transferring, in accordance with the activation of the data path circuitry in response to the power gating signal, the data stored in the memory array via the data path in response to the signaling.

Aspect 2: The method, apparatus, or non-transitory computer-readable medium of aspect 1, where receiving the signaling includes operations, features, circuitry, logic, means, or instructions, or any combination thereof for receiving a command that indicates the transfer of data and that requests generation of the power gating signal.

Aspect 3: The method, apparatus, or non-transitory computer-readable medium of aspect 2, where generating the power gating signal includes operations, features, circuitry, logic, means, or instructions, or any combination thereof for generating, by the other circuitry to process the input and output for the memory array, the power gating signal in response to the command.

Aspect 4: The method, apparatus, or non-transitory computer-readable medium of any of aspects 2 through 3, further including operations, features, circuitry, logic, means, or instructions, or any combination thereof for receiving a data transfer command before or after receiving the command, where the data transfer command requests the transfer of the data via the data path.

Aspect 5: The method, apparatus, or non-transitory computer-readable medium of any of aspects 1 through 4, where receiving the signaling includes operations, features, circuitry, logic, means, or instructions, or any combination thereof for receiving a preamble associated with transferring the data via the data path, where generating the power gating signal is in response to the preamble.

Aspect 6: The method, apparatus, or non-transitory computer-readable medium of any of aspects 1 through 5, further including operations, features, circuitry, logic, means, or instructions, or any combination thereof for receiving, after transferring the data via the data path, second signaling that indicates an end of the transfer of the data and generating, in response to the second signaling that indicates the end of the transfer of the data, a second power gating signal associated with deactivation of the data path circuitry.

Aspect 7: The method, apparatus, or non-transitory computer-readable medium of aspect 6, further including operations, features, circuitry, logic, means, or instructions, or any combination thereof for deactivating the data path circuitry according to the second power gating signal including an input to logic circuitry of the memory system that is to activate or deactivate the data path circuitry according to the input.

Aspect 8: The method, apparatus, or non-transitory computer-readable medium of any of aspects 6 through 7, where the second signaling includes a post-amble associated with a command sequence for transferring the data via the data path or a command that indicates to generate the second power gating signal, or both.

Aspect 9: The method, apparatus, or non-transitory computer-readable medium of any of aspects 1 through 8, further including operations, features, circuitry, logic, means, or instructions, or any combination thereof for activating the data path circuitry according to both a chip enable signal that enables the memory array and the power gating signal including inputs to logic circuitry of the memory system that is to activate or deactivate the data path circuitry according to the inputs.

Aspect 10: The method, apparatus, or non-transitory computer-readable medium of any of aspects 1 through 9, further including operations, features, circuitry, logic, means, or instructions, or any combination thereof for receiving, in response to powering on the memory system, second signaling that enables use of power gating signaling to control the data path circuitry, where the signaling that indicates the transfer of the data is received in accordance with the use of power gating signaling to control the data path circuitry being enabled.

Aspect 11: The method, apparatus, or non-transitory computer-readable medium of any of aspects 1 through 10, further including operations, features, circuitry, logic, means, or instructions, or any combination thereof for receiving a chip enable signal that enables the memory array to receive the input and the output, where the signaling that indicates the transfer of the data is received in accordance with the chip enable signal.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in accordance with the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system for memory operations, comprising:
one or more memory devices; and
processing circuitry coupled with the one or more memory devices and configured to cause the memory system to:
receive signaling that indicates a transfer of data stored in a memory array of the memory system;
generate, in response to the signaling that indicates the transfer of the data, a power gating signal associated with activation of data path circuitry to transfer the data via a data path associated with the memory array, wherein the data path circuitry is different from other circuitry to process input and output for the memory array; and
transfer, in accordance with the activation of the data path circuitry in response to the power gating signal, the data stored in the memory array via the data path in response to the signaling.

2. The memory system of claim 1, wherein receiving the signaling comprises the processing circuitry configured to cause the memory system to:
receive a command that indicates the transfer of data and that requests generation of the power gating signal.

3. The memory system of claim 2, wherein generating the power gating signal comprises the processing circuitry configured to cause the memory system to:
generate, by the other circuitry to process the input and output for the memory array, the power gating signal in response to the command.

4. The memory system of claim 2, wherein the processing circuitry is further configured to cause the memory system to:
receive a data transfer command before or after receiving the command, wherein the data transfer command requests the transfer of the data via the data path.

5. The memory system of claim 1, wherein receiving the signaling comprises the processing circuitry configured to cause the memory system to:
receive a preamble associated with transferring the data via the data path, wherein generating the power gating signal is in response to the preamble.

6. The memory system of claim 1, wherein the processing circuitry is further configured to cause the memory system to:
receive, after transferring the data via the data path, second signaling that indicates an end of the transfer of the data; and
generate, in response to the second signaling that indicates the end of the transfer of the data, a second power gating signal associated with deactivation of the data path circuitry.

7. The memory system of claim 6, wherein the processing circuitry is further configured to cause the memory system to:
deactivate the data path circuitry according to the second power gating signal comprising an input to logic circuitry of the memory system that is to activate or deactivate the data path circuitry according to the input.

8. The memory system of claim 6, wherein the second signaling comprises a post-amble associated with a command sequence for transferring the data via the data path or a command that indicates to generate the second power gating signal, or both.

9. The memory system of claim 1, wherein the processing circuitry is further configured to cause the memory system to:
activate the data path circuitry according to both a chip enable signal that enables the memory array and the power gating signal comprising inputs to logic circuitry of the memory system that is to activate or deactivate the data path circuitry according to the inputs.

10. The memory system of claim 1, wherein the processing circuitry is further configured to cause the memory system to:
receive, in response to powering on the memory system, second signaling that enables use of power gating signaling to control the data path circuitry, wherein the signaling that indicates the transfer of the data is received in accordance with the use of power gating signaling to control the data path circuitry being enabled.

11. The memory system of claim 1, wherein the processing circuitry is further configured to cause the memory system to:
receive a chip enable signal that enables the memory array to receive the input and the output, wherein the signaling that indicates the transfer of the data is received in accordance with the chip enable signal.

12. A non-transitory computer-readable medium storing code comprising instructions which, when executed by processing circuitry of a memory system, cause the memory system to:
receive signaling that indicates a transfer of data stored in a memory array of the memory system;
generate, in response to the signaling that indicates the transfer of the data, a power gating signal associated with activation of data path circuitry to transfer the data via a data path associated with the memory array, wherein the data path circuitry is different from other circuitry to process input and output for the memory array; and
transfer, in accordance with the activation of the data path circuitry in response to the power gating signal, the data stored in the memory array via the data path in response to the signaling.

13. The non-transitory computer-readable medium of claim 12 wherein the instructions to receive the signaling, when executed by the processing circuitry of the memory system, cause the memory system to:
receive a command that indicates the transfer of data and that requests generation of the power gating signal.

14. The non-transitory computer-readable medium of claim 13, wherein the instructions to generate the power gating signal, when executed by the processing circuitry of the memory system, cause the memory system to:
generate, by the other circuitry to process the input and output for the memory array, the power gating signal in response to the command.

15. The non-transitory computer-readable medium of claim 13, wherein the instructions, when executed by the processing circuitry of the memory system, further cause the memory system to:
receive a data transfer command before or after receiving the command, wherein the data transfer command requests the transfer of the data via the data path.

16. The non-transitory computer-readable medium of claim 12, wherein the instructions to receive the signaling, when executed by the processing circuitry of the memory system, cause the memory system to:
receive a preamble associated with transferring the data via the data path, wherein generating the power gating signal is in response to the preamble.

17. The non-transitory computer-readable medium of claim 12, wherein the instructions, when executed by the processing circuitry of the memory system, further cause the memory system to:
receive, after transferring the data via the data path, second signaling that indicates an end of the transfer of the data; and
generate, in response to the second signaling that indicates the end of the transfer of the data, a second power gating signal associated with deactivation of the data path circuitry.

18. The non-transitory computer-readable medium of claim 17, wherein the instructions, when executed by the processing circuitry of the memory system, further cause the memory system to:
deactivate the data path circuitry according to the second power gating signal comprising an input to logic circuitry of the memory system that is to activate or deactivate the data path circuitry according to the input.

19. The non-transitory computer-readable medium of claim 17, wherein the second signaling comprises a post-amble associated with a command sequence for transferring the data via the data path or a command that indicates to generate the second power gating signal, or both.

20. The non-transitory computer-readable medium of claim 12, wherein the instructions, when executed by the processing circuitry of the memory system, further cause the memory system to:
activate the data path circuitry according to both a chip enable signal that enables the memory array and the power gating signal comprising inputs to logic circuitry of the memory system that is to activate or deactivate the data path circuitry according to the inputs.

21. The non-transitory computer-readable medium of claim 12, wherein the instructions, when executed by the processing circuitry of the memory system, further cause the memory system to:
receive, in response to powering on the memory system, second signaling that enables use of power gating signaling to control the data path circuitry, wherein the signaling that indicates the transfer of the data is received in accordance with the use of power gating signaling to control the data path circuitry being enabled.

22. The non-transitory computer-readable medium of claim 12, wherein the instructions, when executed by the processing circuitry of the memory system, further cause the memory system to:
receive a chip enable signal that enables the memory array to receive the input and the output, wherein the signaling that indicates the transfer of the data is received in accordance with the chip enable signal.

23. A method for memory operations at a memory system, comprising:
receiving signaling that indicates a transfer of data stored in a memory array of the memory system;
generating, in response to the signaling that indicates the transfer of the data, a power gating signal associated with activation of data path circuitry to transfer the data via a data path associated with the memory array, wherein the data path circuitry is different from other circuitry to process input and output for the memory array; and
transferring, in accordance with the activation of the data path circuitry in response to the power gating signal, the data stored in the memory array via the data path in response to the signaling.
